(19) United States
(12) Patent Application Publication
(10) Pub. No.: US 2011/0051646 A1
(43) Pub. Date: Mar. 3, 2011

(54) DYNAMIC MULTICASTING

(76) Inventor: Christopher T. Rice, San Antonio, TX (US)

(21) Appl. No.: 12/548,343

(22) Filed: Aug. 26, 2009

(51) Int. Cl. H04H 20/71

(52) U.S. Cl. 370/312; 370/390; 455/456.1

(57) ABSTRACT

When multiple mobile devices request the same content, rather than initiating a dedicated session for providing the content to each respective device, a multicast session is dynamically established to provide the content to all the devices. After the multicast session is established, respective additional requesters of the content are dynamically added to the multicast session responsive to each request. In an example configuration, a Service Center receives a request to provide content to a mobile device in a cellular site and determines if multicasting is warranted, the cellular site in which the mobile device is located, and, if warranted, initiates a multicast session and allocates resources for providing the content to the mobile device in that cellular site. As additional requests for the content are received from other mobile devices, the Service Center dynamically, upon each request, adds the requesters to the multicast session.

### TECHNICAL FIELD

The technical field generally relates to communications systems and more specifically relates to dynamically providing information to multiple devices via a common communications session.

### BACKGROUND

Costs associated with cellular site backhaul are typically one of the highest costs faced by wireless carriers. In a communications network, the backhaul portion comprises the communication links to the edges of the network. For example, in a mobile telecommunications network, the communication links between a Base Station Controller (BSC) and its associated Base Transceiver Stations (BTS) comprise the backhaul portion of the network. When transmitting content, such as multimedia, from a BSC to devices in a cellular site, the provisioning of content is essentially point-to-point, in that, when a Base Station Controller (BSC), or the like, initiates transmission of content to a device, a session is established and a channel is dedicated for the transmission of the content to that device. If another device requests the same content, another session is initiated and another channel is dedicated for the second device. If multiple devices are requesting the same content, establishing a session and dedicating a channel for each device can be an inefficient use of resources and can drive costs dramatically upward.

### SUMMARY

As multiple devices, such as mobile devices, request the same content, the content is dynamically multicast to the multiple devices. Rather than initiating and dedicating a new session for providing the content to each respective device, a single session is dynamically established and utilized to provide the content to all the devices. In an example embodiment, a Service Center receives a request to provide content to a mobile device in a cellular site. Responsive to the request, the Service Center dynamically determines if the content is already being provided via multicast or if multicast provisioning should be initiated. If the content is being provisioned via multicast, the Service Center dynamically, responsive to the request, adds the requester to the multicast. If the content is not being provisioned via multicast, and the Service Center dynamically, responsive to the request, determines that the content should be provided via multicast, the Service Center establishes a multicast session and provides the content to the requester via the multicast session. As additional requests for the content are received by the Service Center, responsive to each individual request, the Service Center dynamically adds the respective requester to the multicast.

In an example embodiment, upon receiving a request from a mobile device, the Service Center determines the cellular site in which the mobile device is located and initiates a session and resource allocation (e.g., channel: bandwidth and spectrum to be used to transmit from the cellular tower to the mobile device) for providing the content to the mobile device in that cellular site. As additional requests for the content are received from other mobile devices in that cellular site, the Service Center, in response to each request, provides the content to the other mobile devices via the same multicast session established for the first mobile device. The Service Center can perform similar functions for each cellular site associated therewith. Thus, when the content is requested by a mobile device in another cellular site, the Service Center can initiate a session and channel allocation to provide the content to the mobile device in the other cellular site. The Service Center also manages handoff from one cellular site to another.

### BRIEF DESCRIPTION OF THE DRAWINGS

The foregoing summary, as well as the following detailed description, is better understood when read in conjunction with the appended drawings.

FIG. 1 is a diagram depicting an example system for implementing dynamic multicasting.

FIG. 2 is an example system and process for dynamic multicasting.

FIG. 3 is a flow diagram of an example process for dynamic multicasting.

FIG. 4 is another flow diagram of an example process for dynamic multicasting.

FIG. 5 is a block diagram of an example processor for implementing dynamic multicasting.

FIG. 6 depicts an overall block diagram of an exemplary packet-based mobile cellular network environment in which dynamic multicasting can be implemented.

FIG. 7 illustrates an architecture of a typical GPRS network in which dynamic multicasting can be implemented.

FIG. 8 illustrates another exemplary block diagram view of a GSM/GPRS/IP multimedia network architecture in which dynamic multicasting can be implemented.

### DETAILED DESCRIPTION OF ILLUSTRATIVE EMBODIMENTS

In a telecommunications network, when the same content, such as multimedia, is requested by multiple devices in a cellular site, rather than initiating and dedicating a unique session for each device, the content is provided to the devices, dynamically upon request, via a dynamically established multicast session. In an example embodiment, as more devices request the same content, the additional devices are dynamically added to the multicast session and the content is provided via the established multicast session. In an example embodiment, indications of each device, the content being provided, and the cellular site and/or sector to which content is being provided, are maintained to ensure that new requests for content are tied into established multicast sessions. The information also can be maintained so that each device can be tracked to ensure that when a device moves from one cellular site to another, the hand off is handled properly so that the content can be provided to the device in the new cellular site. As a device migrates to another cellular site, or when requests are received from other cellular sites, a multicast session is established for each cellular site, and the content is multicast (provided simultaneously) to the devices in a cellular site via the multicast session established for that cellular site.

The content can include real-time, streaming, video, audio, text (e.g., an SMS message), images, multimedia, or a combination thereof. The content can be indicative of, for example, a live event, a sporting event, a concert, a traffic report, a news report, a recorded event, or the like. Devices can include any appropriate type of device capable of receiving the content. Devices can include mobile devices or stationary devices. Some example devices include: a portable media player, e.g., a portable music player, such as an MP3 player, a walkmans, etc., a portable computing device, such as a laptop, a personal digital assistant (“PDA”), a portable phone, such as a cell phone or the like, a smart phone, a Session Initiation Protocol (SIP) phone, a video phone, a portable email device, a thin client, a portable gaming device, etc., consumer electronic devices, such as TVs, DVD players, set top boxes, monitors, displays, etc., a public computing device, such as a kiosk, an in-store music sampling device, an automated teller machine (ATM), a cash register, etc., (e) a navigation device whether portable or installed in-vehicle and/or a non-conventional computing device, such as a kitchen appliance, a motor vehicle control (e.g., steering wheel), etc., or a combination thereof.

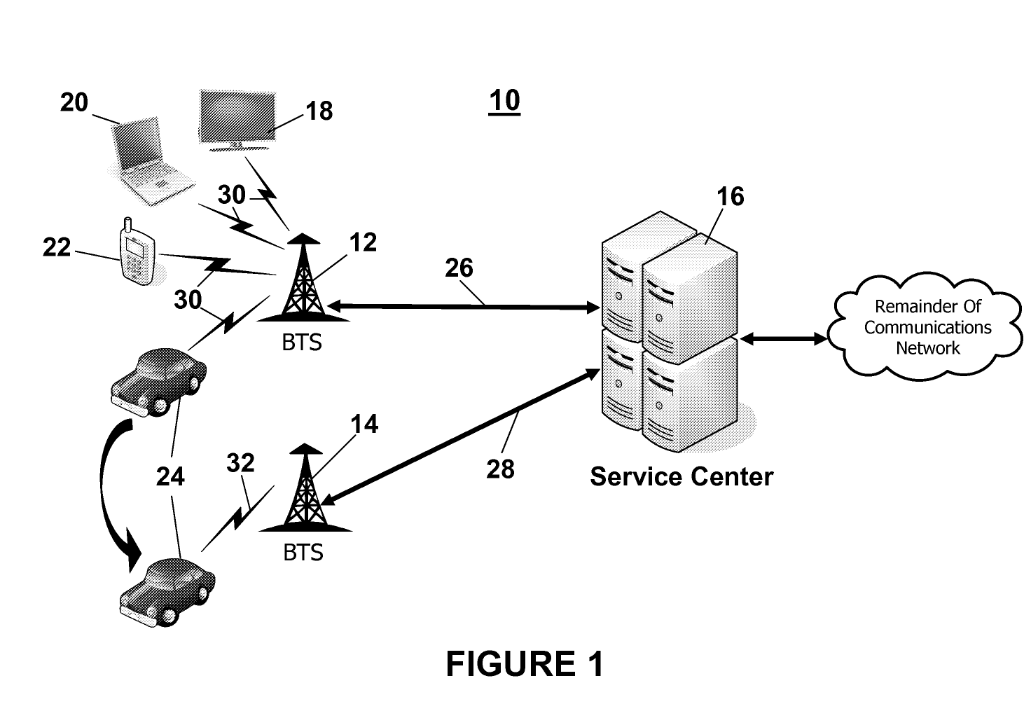

In an example embodiment, dynamic multicasting is accomplished, in a telecommunications network, via at least one Service Center in communication with at least one Base Transceiver Station. FIG. 1 is a diagram depicting an example system 10 for implementing dynamic multicasting in a telecommunications network comprising a Service Center 16, BTSs 12, 14, and communication links 26, 28. The Service Center 16 performs various functions associated with providing content to devices 18, 20, 22, 24. In example embodiments, among other things, the Service Center 16 manages allocation of radio channels for BTS 12 and BTS 14, receives measurements from devices 18, 20, 22, and 24, manages handover from BTS 12 to BTS 14 and vice versa, manages handovers within sectors of a cellular site, manages switching functions, and manages communications to the remainder of the communications network.

It is to be understood that the system 10 depicted in FIG. 1 is but an example of a system for implementing dynamic multicasting, and should not be limited thereto. For example, the number of devices can be more of less than depicted in FIG. 1. The types of devices can differ from those depicted in FIG. 1. The system 10 can comprise more than one Service Center, and each Service Center can be coupled to any appropriate number of BTSs via any appropriate number of communications links. For example, the entity labeled Service Center in FIG. 1 can comprise component or combination of components of a telecommunications network. The functions described herein as being performed by the Service Center, in various embodiments, can be performed by additional entities, such as special purpose processors or the like. The Service Center 16 is representative of any processor, server, database, network entity, or any combination thereof that can be utilized to perform the herein functions of the Service Center 16. For example, the Service Center 16 can comprise a dedicated processor or processors, and/or any combination of known network entities such as, a Base Station Controller (BSC), any gateway server, a Broadcast Multicast Service Center (BM-SC), any node server, a Mobile Switching Center (MSC), a Home Location Register (HLR), an Authentication Center (AuC), database, etc.

As shown in FIG. 1, which depicts an example system for implementing dynamic multicasting, when a device, such as for example, device 22 (e.g., smart phone), requests content (e.g., traffic report), the request is provided to the Service Center 16 via the BTS 12 and the communications link 26. The Service Center 16 determines the cellular site and/or sector (area of coverage of a BTS and associated cellular tower) in which the device 22 is located and determines if a session and channel have been established for that cellular site for providing the requested content. If a session/channel has not been established for providing the content to the cellular site, the Service Center 16 determines if a multicast session is warranted, and if so, initiates a multicast session on the communications link 26 and initiates the establishment of a channel 30 to provide the content to the cellular site associated with the BTS 12. Upon initiating the session and the channel 30, the Service Center 16 instructs the device 22 to tune to the appropriate channel 30 to receive the content, provides the content via the devices IP address, or the like. The content is provided to the device 22 via the established multicast session.

When another device, such as device 20 (e.g., laptop) for example, requests the same content (e.g., traffic report), upon receiving the request, the Service Center 16 determines that a session has been started and that channel 30 has been designated as the channel for providing the content to the cellular site of BTS 12. The BTS 16 then instructs the device 20 to tune to the channel 30 to receive the content, which is already being transmitted, and/or provides the content to the device 20 via the appropriate IP address, or the like. Similarly, when the device 18 (e.g., smart monitor capable of receiving broadcast) requests the content (e.g., traffic report), upon receiving the request, the Service Center 16 determines that a multicast session has been established and dynamically adds the device 18 to the multicast session.

The device 24 is indicative of a vehicle capable of receiving a broadcast of the content, of a mobile device in a vehicle, or the like. As depicted in FIG. 1, the device 24 traverses a cellular site boundary. That is, the device 24 crosses over from the cellular site of BTS 12 to the cellular site of BTS 14. Note that the device 24 could traverse a sector boundary within a cellular site and the Service Center 16 would manage the handover from sector to sector similarly. However, for the sake of simplicity, the system and process are described with respect to traversing a cellular site boundary. Upon the Service Center 16 receiving an indication that the device 24 has migrated from the cellular site of BTS 12 to the cellular site of BTS 14, the Service Center 16 determines if a session and channel have been established for providing the content to the cellular site of BTS 14. If not, the BTS 16 initiates a session over communications link 28 and establishes a channel 32 for providing the content to the cellular site of BTS 14. The device 24 then is instructed to tune to the channel 34 to receive the content. The content is provided by the Service Center 16 to the device 24 in the cellular site of BTS 14 via the session established on the communications link 28 and the channel 32.

As depicted in FIG. 1, channels 30 and 32 are radio channels parameterized by predetermined values of bandwidth, spectrum, frequency, time, modulation scheme, or a combination thereof. It is to be understood however, that a channel is not limited to a radio channel. A channel can include any appropriate means for providing content to a device, such as, for example, Bluetooth, optical (e.g., Infrared), sonic, ultrasonic, an Internet Protocol, or a combination thereof.

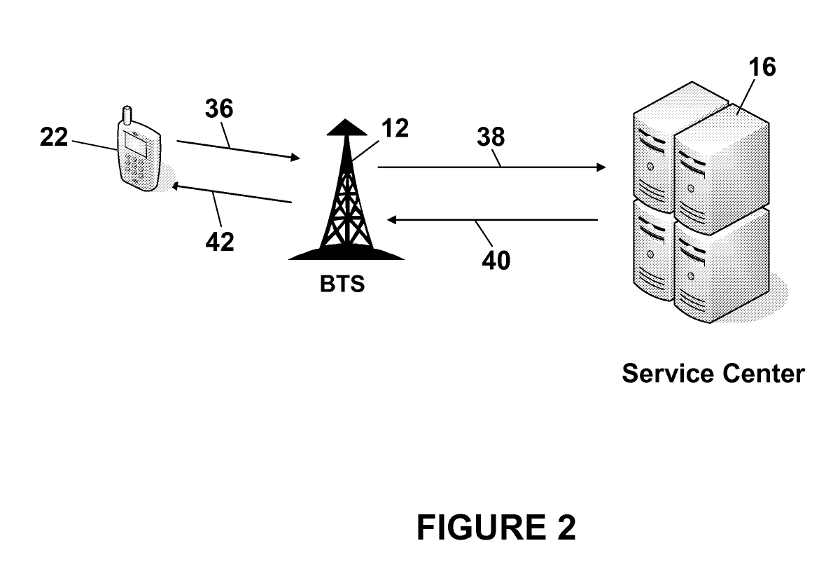

FIG. 2 is a diagram depicting an example system and process for implementing dynamic multicasting in a telecommunications network comprising the Service Center 16, the BTS 12, and the mobile device 22. At step 36, the mobile device 22, sends a request for content. As described above, the content can comprise audio, text (e.g., an SMS message), images, multimedia, or a combination thereof. For example, the mobile device 22 can request a live stream of a sporting event, such as a football game, or the like. In an example embodiment, the request also contains information about the mobile device 22, such as an identifier of the mobile device 22, transmission/reception conditions, or the like. The BTS 12 receives the request provided at step 36, by the mobile device 22. The BTS 12 determines, in accordance with the received request, information about the location of the mobile device 22, such as the cellular site and/or sector in which the mobile device 22 is located. At step 38, the BTS 12 provides an indication of the request to the Service Center 16. In an example embodiment, the BTS 12 also provides, at step 38, additional information such as, for example, information pertaining to the identification of the mobile device 22 and/or information pertaining to the location of the mobile device 22 (e.g., cellular site, sector), or the like. The Service Center 16 receives the indication of the request and any other information and makes various determinations. For example, the Service Center 16 can determine if the mobile device is authorized to request the content. This can be accomplished, for example, by analyzing the identifier of the mobile device 22. As is known in the art, other entities, such a home location register (HLR) or the like, in the network may be utilized to determine if the mobile device 22 is authorized to receive the requested content.

Upon receiving the indication of the request (at step 38), the Service Center 16 dynamically determines if a multicast session has been established for providing the content, and if not, dynamically determines whether a multicast session should be established. The Service Center 16 then determines if a multicast session has been established for providing the requested content to the cellular site/sector in any appropriate manner. For example, the Service Center 16 can maintain a list or database of information such as content requested, cellular site/sector from which the content was requested, session established for providing the content to the cellular site/sector, channel established for providing the content to the cellular site/sector, or the like. If a multicast session has not been established for the content/location combination, and it is determined that a multicast session should be established, the Service Center 16 dynamically establishes a multicast session, and provides content and instructions to the BTS 12 to be forwarded to the mobile device 22, vi the newly established multicast session. If a multicast session has been established for the content/location combination, the Service Center 16 dynamically adds the requesting device to the multicast session and utilizes the established multicast session to provide content and instructions to the BTS 12 to be forwarded to the mobile device 22. The Service Center 16 also can determine the cellular cite and/or sector from which the request was made. This can be determined via any appropriate means. For example, the cellular site and/or sector from which the request was made can be determined in accordance with information provided by the BTS 12 pertaining to the location of the mobile device 22.

At step 40, the Service Center 16 provides content and/or any appropriate instructions to the BTS 12. If the mobile device 22 is authorized to receive the requested content, at step 42, the Service Center 16 provides, via the BTS 12, the requested content to the mobile device 22 via the established multicast session. As additional devices within a cellular site/sector request content, they will similarly be dynamically added to the multicast session. As conditions change and a new channel is to be used, for example weather conditions require a different channel to be used, content is provided via the new channel accordingly.

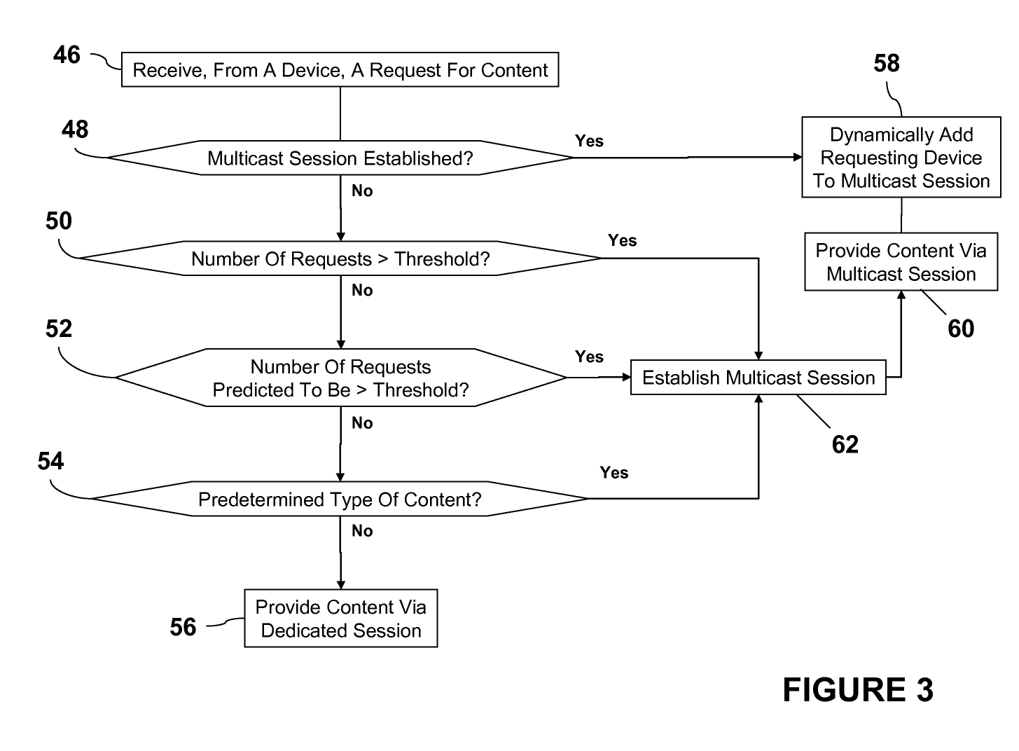

FIG. 3 is a flow diagram of an example process for dynamic multicasting. It is to be understood that, in various embodiments, the process depicted in FIG. 3 can be accomplished via various system configurations in various types of networks, and that the process depicted in FIG. 3 is not to be construed as being limited to a specific implementation.

At step 46, a request for content is received from a device. The device can comprise any appropriate device capable of providing the request, such as for example, a mobile device or a stationary device, as described above. The request is a request for content, such as video, audio, text (e.g., an SMS message), images, multimedia, or a combination thereof. The request can be received by any appropriate entity, such as for example, any appropriate processor, the Service Center, or a combination thereof. At step 48, responsive to the request at step 46, it is determined if a multicast session has been established for providing the requested content. If it is determined, by the Service Center for example, at step 48, that a multicast session has been established, the requesting device, in response to the request at step 46, dynamically is added to the multicast session, at step 58. The content is provided to the requesting device via the multicast session at step 60.

If, at step 48, it is determined that a multicast session has not been established for providing the content requested at step 46, it is determined (at step 50) if the number of requests for the content from different devices has exceeded a predetermined threshold number of requests. If the number of requests for the content from different devices has exceeded a predetermined threshold number of requests, a multicast session is dynamically established, at step 62, in response to the request. The threshold number of requests can be any appropriate number of requests. For example, the threshold number can be 1. Thus, a second request for the same content by a second device could cause the establishment of a multicast session for providing the content. As another example, the threshold number can be a percentage (e.g., 2%, 5%, 10%, 20%, etc.) of the known subscribers for the content. As yet another example, the threshold number can be a number determined by the availability of resources (e.g., bandwidth, channel capacity, time of day indicating peak of non-peak usage, etc.). As another example, the threshold number can be an arbitrary or calculated number, such as 100, 200, 1000, or 2000. The predetermined number can be dynamic or static. That predetermined number can be updated as appropriate.

If it is determined, at step 50, that the number of requests for the content from different devices has not exceeded the predetermined threshold number of requests, it is determined, at step 52 if the number of requests for the content from different devices is predicted to exceed a predetermined threshold number of requests. For example, the content may be a multimedia broadcast of a presidential debate, and may be anticipated that a large number of subscribers will want to receive the content on their mobile devices. In this example scenario, when the first request for the content (the presidential debate) is received, a multicast session will dynamically, responsive to the request, be established for providing the content to the requesting device. If it is determined, at step 52 that the number of requests for the content from different devices is predicted to exceed a predetermined threshold number of requests, a multicast session is dynamically established at step 62.

If it is determined, at step 52 that the number of requests for the content from different devices is not predicted to exceed a predetermined threshold number of requests, it is determined, at step 54, if the requested content is of a predetermined type of content. The predetermined type of content can comprise any appropriate type of content. For example, the predetermined type of content can include a live event (e.g., sporting event, concert, etc,) wherein the content is provided concurrent with the occurrence of the event. Other examples of the predetermined type of content can include a sporting event (live or recorded), a concert (live or recorded), a traffic report, a news report, or any appropriate recorded event. In an example embodiment, the predetermined type of content includes content that is known or expected to be popular with subscribers. If it is determined, at step 54, that the requested content is of a predetermined type of content, a multicast session is dynamically established at step 62. If it is determined, at step 54, that the requested content is not of a predetermined type of content, the requested content is provided via a dedicated session at step 56.

From step 62, at which a multicast session is dynamically established response to a request for content, the process proceeds to step 60, at which the content is provided via the dynamically established multicast session.

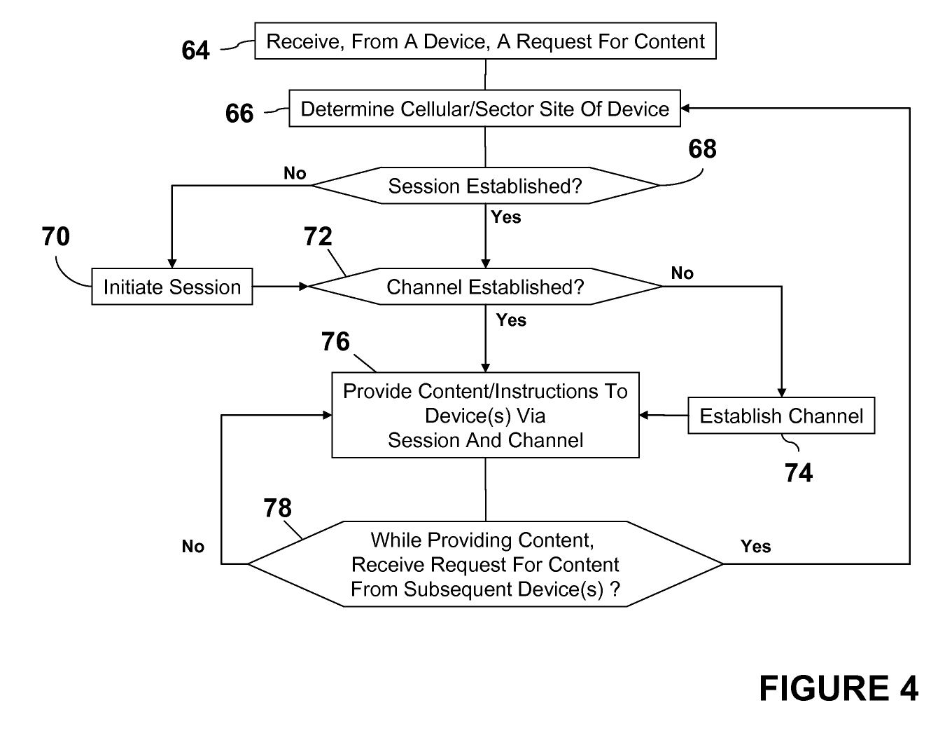

FIG. 4 is a flow diagram of an example process for dynamic multicasting. It is to be understood that, in various embodiments, the process depicted in FIG. 4 can be accomplished via various system configurations in various types of networks, and that the process depicted in FIG. 4 is not to be construed as being limited to a specific implementation.

At step 64, a request is received from a device. The device can comprise any appropriate device capable of providing the request, such as for example, a mobile device or a stationary device, as described above. The request is a request for content, such as video, audio, text (e.g., an SMS message), images, multimedia, or a combination thereof. The request can be received by any appropriate entity, such as for example, any appropriate processor, the Service Center, or a combination thereof. At step 66, the cellular site and/or sector within a cellular site from which the request was made is determined. The cellular site/sector can be determined by any appropriate entity, such as the entity receiving the request, or another entity as requested by the entity receiving the request. For example, the request can be received by a Service Center and the Service Center can determine the cellular site/sector. Or, the Service Center can pass information to another processor to determine the cellular site/sector. The determination of the cellular site/sector from which the request was sent can be made in accordance with any appropriate manner, such as in accordance with, as described above, information provided with the request. For example, a BTS can provide information to the Service Center indicative of the cellular site/sector from which the request was received. This information could include additional information pertaining to the location of the device requesting the content, such as for example, Global Positioning System (GPS) data, Assisted GPS data, time difference of arrival (TDA) data (e.g., triangulation, hyperbolic intersections), or the like. This information can be used to determine the cellular site/sector in which a device is located, and if a device is located in more than one cellular site/sector, the best cellular site/sector and associated BTS to use to provide the content to the mobile device.

At step 68, it is determined if a session has been established for providing the requested content to the device in the determined cellular site/sector. If no session has been established, a session is established at step 70. A session can be established in any appropriate manner. For example, a session can be established in accordance with the 3^{rd} Generation Partnership Project; Technical Specification Group Services and System Aspects; Multimedia Broadcast/Multicast Service (MBMS); Architecture and Functional Description (Release 8) (2GPP TS 23.246 V8.2.0) 2008-06, which is hereby incorporated by reference in its entirety. The process proceeds to step 72, at which, it is determined if a channel has been established for providing the requested content to the device in the determined cellular site/sector. If, at step 68, it is determined that a session has been established for providing the requested content to the device in the determined cellular site/sector, the process proceeds to step 72, at which it is determined if a channel has been established for providing the requested content to the determined cellular site/sector. If it is determined (at step 72) that no channel has been established, a channel is established at step 74. A channel can be established in accordance with any appropriate manner. For example, a channel can be established via negotiations between a Service Center and a BTS utilizing channel availability and/or propagation conditions, or the like. The process proceeds to step 76 at which the content and appropriate instructions are provided to the device at step 76. If it is determined (at step 72) that a channel has been established, the content and appropriate instructions are provided to the device at step 76. Appropriate instructions can include an instruction to the device to tune to the established channel.

As depicted at step 78, while content is being provided to the device (at step 76), one or more subsequent requests for the same content or different content can be received from other devices in the same cellular site/sector and/or other devices in other cellular sites/sectors. Upon receipt of a subsequent request, the process proceeds to step 66, and thereafter dynamically determines if a session and/or channel has been established for providing the subsequently requested content to the subsequent device(s). If a session and channel have been established for providing the content to the subsequent device(s), the established session and channel dynamically are utilized to provide the content to the subsequent device(s). If a session and channel have not been established for providing the content to the subsequent device(s), session(s) and channel(s) dynamically are established and utilized to provide the content to the subsequent device(s). It is to be understood that the order of steps as depicted in FIG. 1 may vary. For example, a channel can be established before a session, a session can be established before a channel, or a channel and a session can be established concurrently.

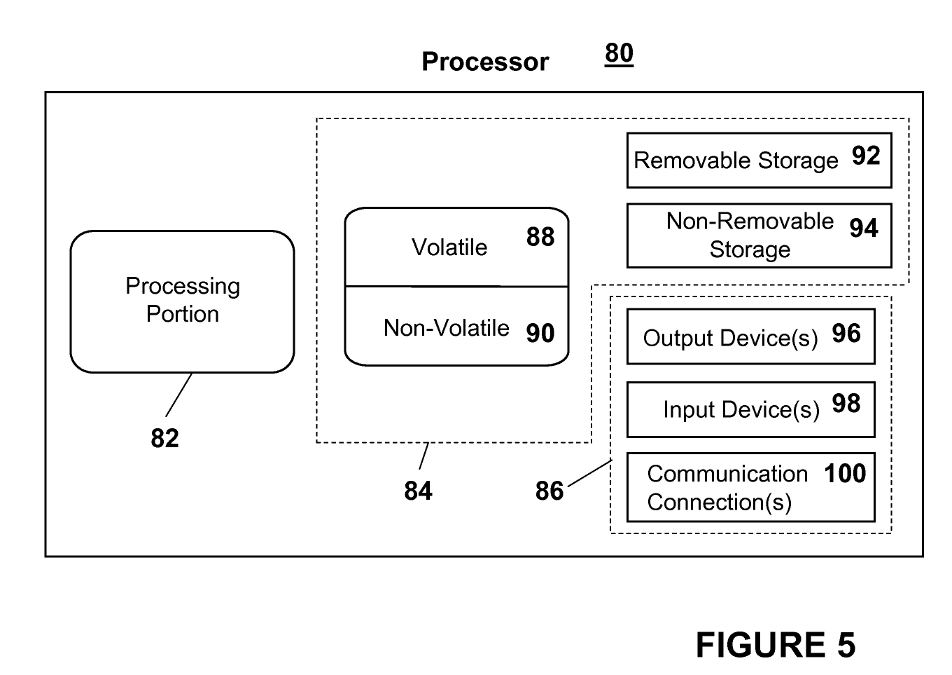

FIG. 5 is a block diagram of an example processor 80 for implementing dynamic multicasting. In an example configuration, the processor 80 comprises various appropriate components of the cellular broadcast system wireless network, various components of the Service Center, various components of the BTS, various components of the device, or a combination thereof. It is emphasized that the block diagram depicted in FIG. 5 is exemplary and not intended to imply a specific implementation. Thus, the processor 80 can be implemented in a single processor or multiple processors. Multiple processors can be distributed or centrally located. Multiple processors can communicate wirelessly, via hard wire, or a combination thereof.

The processor 80 comprises a processing portion 82, a memory portion 84, and an input/output portion 86. The processing portion 82, memory portion 84, and input/output portion 86 are coupled together (coupling not shown in FIG. 5) to allow communications therebetween. The processor 80 can be implemented as a client processor and/or a server processor. In a basic configuration, the processor 80 can include at least one processing portion 82 and memory portion 84. The processing portion 82 is capable of performing functions for implementing dynamic multicasting. For example, the processing portion 82, as described above, is capable of dynamically while providing content to a device, determining if a session has been established, determining if a channel has been established, establishing a session, establishing a channel, determining if a device has moved from one cellular site/sector to another cellular site/sector, or a combination thereof.

The input/output portion 86 is capable of providing and/or receiving components utilized to implement dynamic multicasting as described above. For example, as described above, the input/output portion 86 is capable of receiving and/or providing a request for content, receiving and/or providing instructions to tune to a channel, receiving and/or providing a request to determine the location of the device, receiving and/or providing data utilized to initiate a session, receiving and/or providing data utilized to establish a channel, or a combination thereof. The processor also can contain communications connection(s) 100 that allow the processor 80 to communicate with other devices, for example. Communications connection(s) 100 can be connected to communication media. Communication media typically embody computer readable instructions, data structures, program modules, or other data in a modulated data signal such as a carrier wave or other transport mechanism, and include any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor also can have input device(s) 98 such as keyboard, mouse, pen, voice input device, touch input device, etc. Output device(s) 96 such as a display, speakers, printer, etc. also can be included.

The memory portion 84 can be indicative of memory internal to a processor or processors, memory external to a processor or processors, a database, or the like, or a combination thereof. The memory portion 84 can store any information utilized in conjunction with dynamic multicasting. For example, as described above, the memory portion 84 is capable of storing information pertaining to cellular sites/sectors associated with requested content, information pertaining to device identifiers, information pertaining to available channels, information pertaining to session parameters, information pertaining to channel parameters, information pertaining to whether a device is authorized to receive requested content, or a combination thereof. Depending upon the exact configuration and type of processor, the memory portion 84 can be volatile (such as RAM) 88, non-volatile (such as ROM, flash memory, etc.) 90, or a combination thereof. The processor 80 can have additional features/functionality. For example, the processor 80 can include additional storage (removable storage 92 and/or non-removable storage 94) including, but not limited to, magnetic or optical disks, tape, flash, smart cards or a combination thereof. Computer storage media can include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor. Any such computer storage media can be part of the processor 80.

The BTS and Service Center as depicted in FIG. 1 and FIG. 2 can be part of any appropriate telecommunications network. The following description sets forth some exemplary telecommunications networks, such as the global system for mobile communications (GSM), and non-limiting operating environments. The below-described operating environments should be considered non-exhaustive, however, and thus the below-described network architectures merely show how utilization of dynamic multicasting can be incorporated with existing network structures and architectures. It can be appreciated, however, that utilization of dynamic multicasting can be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (“GPRS”), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1× Evolution Data Optimized (“EVDO”), Code Division Multiple Access-2000 (“cdma2000 3×”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), 4G Services such as Long Term Evolution (LTE), etc., as well as to other network services that become available in time. In this regard, the techniques of dynamic multicasting can be applied independently of the method of data transport, and do not depend on any particular network architecture, or underlying protocols.

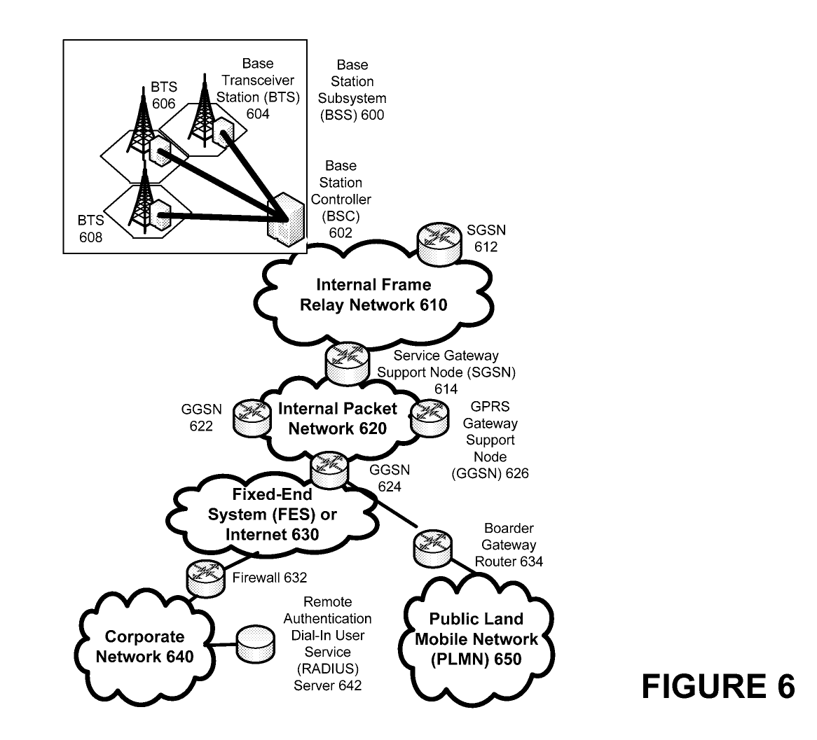

FIG. 6 depicts an overall block diagram of an exemplary packet-based mobile cellular network environment, such as a GPRS network, in which utilization of IP cellular broadcast systems to receive multimedia alerts can be practiced. In an example configuration, the Service Center 16 and BTS 12 as depicted in FIG. 1 and FIG. 2 are encompassed by the network environment depicted in FIG. 6. Thus, the Service Center can appropriately comprise any entity, or combination of entities depicted in FIG. 6. In such an environment, there are a plurality of Base Station Subsystems (“BSS”) 600 (only one is shown), each of which comprises a Base Station Controller (“BSC”) 602 serving a plurality of Base Transceiver Stations (“BTS”) such as BTSs 604, 606, and 608. BTSs 604, 606, 608, etc. are the access points where users of packet-based mobile devices (e.g., devices 18, 20, 22, 24) become connected to the wireless network. In exemplary fashion, the packet traffic originating from user devices (e.g., devices 18, 20, 22, 24) is transported via an over-the-air interface to a BTS 608, and from the BTS 608 to the BSC 602. Base station subsystems, such as BSS 600, are a part of internal frame relay network 610 that can include Service GPRS Support Nodes (“SGSN”) such as SGSN 612 and 614. Each SGSN is connected to an internal packet network 620 through which a SGSN 612, 614, etc. can route data packets to and from a plurality of gateway GPRS support nodes (GGSN) 622, 624, 626, etc. As illustrated, SGSN 614 and GGSNs 622, 624, and 626 are part of internal packet network 620. Gateway GPRS serving nodes 622, 624, and 626 mainly provide an interface to external Internet Protocol (“IP”) networks such as Public Land Mobile Network (“PLMN”) 650, corporate intranets 640, or Fixed-End System (“FES”) or the public Internet 630. As illustrated, subscriber corporate network 640 may be connected to GGSN 624 via firewall 632; and PLMN 650 is connected to GGSN 624 via boarder gateway router 634. The Remote Authentication Dial-In User Service (“RADIUS”) server 642 may be used for caller authentication when a user of a mobile cellular device calls corporate network 640.

Generally, there can be four different cellular site sizes in a GSM network, referred to as macro, micro, pico, and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. On the other hand, umbrella cells are used to cover shadowed regions of smaller cells and fill in gaps in coverage between those cells.

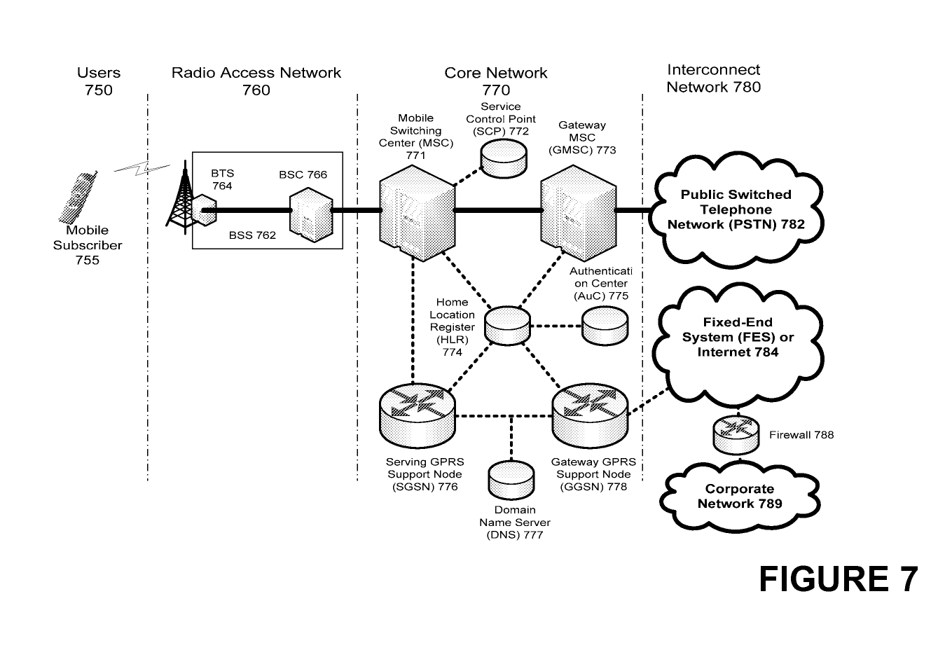

FIG. 7 illustrates an architecture of a typical GPRS network segmented into four groups: users 750, radio access network 760, core network 770, and interconnect network 780. The Service Center can appropriately comprise any entity, or combination of entities depicted in FIG. 7. Users 750 comprise a plurality of end users (though only mobile subscriber 755 is shown in FIG. 7). In an example embodiment, the device depicted as mobile subscriber 755 comprises devices 18, 20, 22, 24. Radio access network 760 comprises a plurality of base station subsystems such as BSSs 762, which include BTSs 764 and BSCs 766. Core network 770 comprises a host of various network elements. As illustrated here, core network 770 may comprise Mobile Switching Center (“MSC”) 771, Service Control Point (“SCP”) 772, gateway MSC 773, SGSN 776, Home Location Register (“HLR”) 774, Authentication Center (“AuC”) 775, Domain Name Server (“DNS”) 777, and GGSN 778. Interconnect network 780 also comprises a host of various networks and other network elements. As illustrated in FIG. 7, interconnect network 780 comprises Public Switched Telephone Network (“PSTN”) 782, Fixed-End System (“FES”) or Internet 784, firewall 788, and Corporate Network 789.

A mobile switching center can be connected to a large number of base station controllers. At MSC 771, for instance, depending on the type of traffic, the traffic may be separated in that voice may be sent to Public Switched Telephone Network (“PSTN”) 782 through Gateway MSC (“GMSC”) 773, and/or data may be sent to SGSN 776, which then sends the data traffic to GGSN 778 for further forwarding.

When MSC 771 receives call traffic, for example, from BSC 766, it sends a query to a database hosted by SCP 772. The SCP 772 processes the request and issues a response to MSC 771 so that it may continue call processing as appropriate.

The HLR 774 is a centralized database for users to register to the GPRS network. HLR 774 stores static information about the subscribers such as the International Mobile Subscriber Identity (“IMSI”), subscribed services, and a key for authenticating the subscriber. HLR 774 also stores dynamic subscriber information such as the current location of the mobile subscriber. Associated with HLR 774 is AuC 775. AuC 775 is a database that contains the algorithms for authenticating subscribers and includes the associated keys for encryption to safeguard the user input for authentication.

In the following, depending on context, the term “mobile subscriber” sometimes refers to the end user and sometimes to the actual device, such as the devices 18, 20, 22, 24, used by an end user of the mobile cellular service. When a mobile subscriber turns on his or her mobile device, the mobile device goes through an attach process by which the mobile device attaches to an SGSN of the GPRS network. In FIG. 7, when mobile subscriber 755 initiates the attach process by turning on the network capabilities of the mobile device, an attach request is sent by mobile subscriber 755 to SGSN 776. The SGSN 776 queries another SGSN, to which mobile subscriber 755 was attached before, for the identity of mobile subscriber 755. Upon receiving the identity of mobile subscriber 755 from the other SGSN, SGSN 776 requests more information from mobile subscriber 755. This information is used to authenticate mobile subscriber 755 to SGSN 776 by HLR 774. Once verified, SGSN 776 sends a location update to HLR 774 indicating the change of location to a new SGSN, in this case SGSN 776. HLR 774 notifies the old SGSN, to which mobile subscriber 755 was attached before, to cancel the location process for mobile subscriber 755. HLR 774 then notifies SGSN 776 that the location update has been performed. At this time, SGSN 776 sends an Attach Accept message to mobile subscriber 755, which in turn sends an Attach Complete message to SGSN 776.

After attaching itself with the network, mobile subscriber 755 then goes through the authentication process. In the authentication process, SGSN 776 sends the authentication information to HLR 774, which sends information back to SGSN 776 based on the user profile that was part of the user's initial setup. The SGSN 776 then sends a request for authentication and ciphering to mobile subscriber 755. The mobile subscriber 755 uses an algorithm to send the user identification (ID) and password to SGSN 776. The SGSN 776 uses the same algorithm and compares the result. If a match occurs, SGSN 776 authenticates mobile subscriber 755.

Next, the mobile subscriber 755 establishes a user session with the destination network, corporate network 789, by going through a Packet Data Protocol (“PDP”) activation process. Briefly, in the process, mobile subscriber 755 requests access to the Access Point Name (“APN”), for example, UPS.com, and SGSN 776 receives the activation request from mobile subscriber 755. SGSN 776 then initiates a Domain Name Service (“DNS”) query to learn which GGSN node has access to the UPS.com APN. The DNS query is sent to the DNS server within the core network 770, such as DNS 777, which is provisioned to map to one or more GGSN nodes in the core network 770. Based on the APN, the mapped GGSN 778 can access the requested corporate network 789. The SGSN 776 then sends to GGSN 778 a Create Packet Data Protocol (“PDP”) Context Request message that contains necessary information. The GGSN 778 sends a Create PDP Context Response message to SGSN 776, which then sends an Activate PDP Context Accept message to mobile subscriber 755.

Once activated, data packets of the call made by mobile subscriber 755 can then go through radio access network 760, core network 770, and interconnect network 780, in a particular fixed-end system or Internet 784 and firewall 788, to reach corporate network 789.

Thus, network elements that can invoke the functionality dynamic multicasting can include but are not limited to Gateway GPRS Support Node tables, Fixed End System router tables, firewall systems, VPN tunnels, and any number of other network elements as required by the particular digital network.

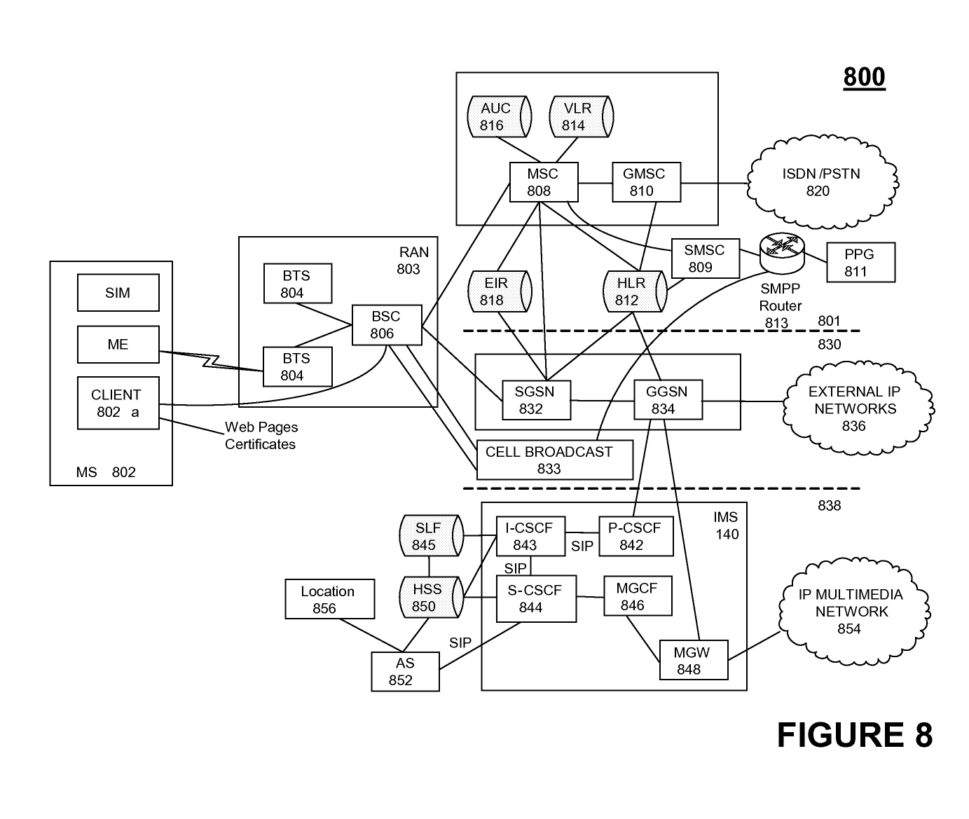

FIG. 8 illustrates another exemplary block diagram view of a GSM/GPRS/IP multimedia network architecture 800 within which dynamic multicasting can be incorporated. The Service Center can appropriately comprise any entity, or combination of entities depicted in FIG. 8. As illustrated, architecture 800 of FIG. 8 includes a GSM core network 801, a GPRS network 830 and an IP multimedia network 838. The GSM core network 801 includes a Mobile Station (MS) 802, at least one Base Transceiver Station (BTS) 804 and a Base Station Controller (BSC) 806. The MS 802 is physical equipment or Mobile Equipment (ME), such as a mobile phone or a laptop computer (e.g., devices 18, 20, 22, 24) that is used by mobile subscribers, with a Subscriber identity Module (SIM). The SIM includes an International Mobile Subscriber Identity (IMSI), which is a unique identifier of a subscriber. The BTS 804 is physical equipment, such as a radio tower, that enables a radio interface to communicate with the MS. Each BTS may serve more than one MS. The BSC 806 manages radio resources, including the BTS. The BSC may be connected to several BTSs. The BSC and BTS components, in combination, are generally referred to as a base station (BSS) or radio access network (RAN) 803.

The GSM core network 801 also includes a Mobile Switching Center (MSC) 808, a Gateway Mobile Switching Center (GMSC) 810, a Home Location Register (HLR) 812, Visitor Location Register (VLR) 814, an Authentication Center (AuC) 818, and an Equipment Identity Register (EIR) 816. The MSC 808 performs a switching function for the network. The MSC also performs other functions, such as registration, authentication, location updating, handovers, and call routing. The GMSC 810 provides a gateway between the GSM network and other networks, such as an Integrated Services Digital Network (ISDN) or Public Switched Telephone Networks (PSTNs) 820. Thus, the GMSC 810 provides interworking functionality with external networks.

The HLR 812 is a database that contains administrative information regarding each subscriber registered in a corresponding GSM network. The HLR 812 also contains the current location of each MS. The VLR 814 is a database that contains selected administrative information from the HLR 812. The VLR contains information necessary for call control and provision of subscribed services for each MS currently located in a geographical area controlled by the VLR. The HLR 812 and the VLR 814, together with the MSC 808, provide the call routing and roaming capabilities of GSM. The AuC 816 provides the parameters needed for authentication and encryption functions. Such parameters allow verification of a subscriber's identity. The EIR 818 stores security-sensitive information about the mobile equipment.

A Short Message Service Center (SMSC) 809 allows one-to-one Short Message Service (SMS) messages to be sent to/from the MS 802. A Push Proxy Gateway (PPG) 811 is used to “push” (i.e., send without a synchronous request) content to the MS 802. The PPG 811 acts as a proxy between wired and wireless networks to facilitate pushing of data to the MS 802. A Short Message Peer to Peer (SMPP) protocol router 813 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 802 sends a location update including its current location information to the MSC/VLR, via the BTS 804 and the BSC 806. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 830 is logically implemented on the GSM core network architecture by introducing two packet-switching network nodes, a serving GPRS support node (SGSN) 832, a cell broadcast and a Gateway GPRS support node (GGSN) 834. The SGSN 832 is at the same hierarchical level as the MSC 808 in the GSM network. The SGSN controls the connection between the GPRS network and the MS 802. The SGSN also keeps track of individual MS's locations and security functions and access controls.

A Cell Broadcast Center (CBC) 833 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 834 provides a gateway between the GPRS network and a public packet network (PDN) or other IP networks 836. That is, the GGSN provides interworking functionality with external networks, and sets up a logical link to the MS through the SGSN. When packet-switched data leaves the GPRS network, it is transferred to an external TCP-IP network 836, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 830 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

The IP multimedia network 838 was introduced with 3GPP Release 5, and includes an IP multimedia subsystem (IMS) 840 to provide rich multimedia services to end users. A representative set of the network entities within the IMS 840 are a call/session control function (CSCF), a media gateway control function (MGCF) 846, a media gateway (MGW) 848, and a master subscriber database, called a home subscriber server (HSS) 850. The HSS 850 may be common to the GSM network 801, the GPRS network 830 as well as the IP multimedia network 838.

The IP multimedia system 840 is built around the call/session control function, of which there are three types: an interrogating CSCF (I-CSCF) 843, a proxy CSCF (P-CSCF) 842, and a serving CSCF (S-CSCF) 844. The P-CSCF 842 is the MS's first point of contact with the IMS 840. The P-CSCF 842 forwards session initiation protocol (SIP) messages received from the MS to an SIP server in a home network (and vice versa) of the MS. The P-CSCF 842 may also modify an outgoing request according to a set of rules defined by the network operator (for example, address analysis and potential modification).

The I-CSCF 843, forms an entrance to a home network and hides the inner topology of the home network from other networks and provides flexibility for selecting an S-CSCF. The I-CSCF 843 may contact a subscriber location function (SLF) 845 to determine which HSS 850 to use for the particular subscriber, if multiple HSS's 850 are present. The S-CSCF 844 performs the session control services for the MS 802. This includes routing originating sessions to external networks and routing terminating sessions to visited networks. The S-CSCF 844 also decides whether an application server (AS) 852 is required to receive information on an incoming SIP session request to ensure appropriate service handling. This decision is based on information received from the HSS 850 (or other sources, such as an application server 852). The AS 852 also communicates to a location server 856 (e.g., a Gateway Mobile Location Center (GMLC)) that provides a position (e.g., latitude/longitude coordinates) of the MS 802.

The HSS 850 contains a subscriber profile and keeps track of which core network node is currently handling the subscriber. It also supports subscriber authentication and authorization functions (AAA). In networks with more than one HSS 850, a subscriber location function provides information on the HSS 850 that contains the profile of a given subscriber.

The MGCF 846 provides interworking functionality between SIP session control signaling from the IMS 840 and ISUP/BICC call control signaling from the external GSTN networks (not shown). It also controls the media gateway (MGW) 848 that provides user-plane interworking functionality (e.g., converting between AMR- and PCM-coded voice). The MGW 848 also communicates with other IP multimedia networks 854.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of dynamic multicasting in a telecommunications network have been described in connection with various computing devices/processor, the underlying concepts can be applied to any computing device, processor, or system capable of implementing dynamic multicasting in a telecommunications network. The various techniques described herein can be implemented in connection with hardware or software or, where appropriate, with a combination of both. Thus, the methods and apparatuses for dynamic multicasting, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for dynamic multicasting. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for dynamic multicasting in a telecommunications network also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for dynamic multicasting. When implemented on a general-purpose processor, the program code combines with the processor to provide a unique apparatus that operates to invoke the functionality of dynamic multicasting. Additionally, any storage techniques used in connection with dynamic multicasting can invariably be a combination of hardware and software.

While the dynamic multicasting in a telecommunications network has been described in connection with the various embodiments of the various figures, it is to be understood that other similar embodiments can be used or modifications and additions can be made to the described embodiment for performing the same function of dynamic multicasting in a telecommunications network without deviating therefrom. For example, one skilled in the art will recognize that dynamic multicasting in a telecommunications network a as described in the present application may apply to any environment, whether wired or wireless, and may be applied to any number of such devices connected via a communications network and interacting across the network. Therefore, dynamic multicasting in a telecommunications network should not be limited to any single embodiment, but rather should be construed in breadth and scope in accordance with the appended claims.

What is claimed:

1. A method for providing content, the method comprising:
receiving a request to provide content to a first device, wherein a session for providing the content to the first device has not been established;
dynamically determining at least one of:
if a number of requests for the content has exceeded a predetermined threshold number of requests,
if a number of requests for the content is predicted to exceed the predetermined threshold number of requests, or
if the content is of a predetermined type of content;
if it is dynamically determined that a number of requests for the content has exceeded a predetermined threshold number of requests, the number of requests for the content is predicted to exceed the predetermined threshold number of request, or the content is of a predetermined type of content:
dynamically establishing a multicast session for providing the content; and
providing the content to the first device via the multicast session; and
if it is dynamically determined that a number of requests for the content has not exceeded a predetermined threshold number of requests, the number of requests for the content is not predicted to exceed the predetermined threshold number of request, and the content is not of a predetermined type of content:
establishing a dedicated session for providing the content; and
providing the content to the first device via the dedicated session.

2. The method in accordance with claim 1, wherein the first device is a mobile device.

3. The method in accordance with claim 1, wherein a multicast session has been established for providing the content to the first device, the method further comprising:
receiving a request to provide the content to at least one other device different from the first device;
determining a first location of the first device;
determining a respective location for each of the at least one other device;
for each of the at least one other device having a respective location that is the same as the first location, providing the content thereto via the established multicast session for the first location;
for each of the at least one other device having a respective location that is not the same as the first location:
establishing a multicast session for providing the content within each location that is not the same as the first location; and
providing the content to the at least one other device having a respective location that is not the same as the first location via the multicast session established for the respective location.

4. The method in accordance with claim 3, wherein each location is respectively indicative of one a cellular site or a sector within a cellular site.

5. The method in accordance with claim 1, wherein the content is indicative of at least one of graphic content, video content, audio content, textual content, or multimedia content.

6. The method in accordance with claim 1, wherein the predetermined type of content comprises content indicative of an event to be provided concurrent with occurrence of the event.

7. The method in accordance with claim 1, wherein the predetermined type of content comprises content indicative of at least one of a sporting event, a concert, a traffic report, a news report, or a recorded event.

8. A system for providing content, the system comprising:
an input/output portion configured to:
receive a request to provide content to a first device, wherein a session for providing the content to the first device has not been established;
provide the content to the first device via a multicast session; and
provide the content to the first device via a dedicated session;
a processing portion configured to:
dynamically determine at least one of:
if a number of requests for the content has exceeded a predetermined threshold number of requests,
if a number of requests for the content is predicted to exceed the predetermined threshold number of requests, or
if the content is of a predetermined type of content;
dynamically establish the multicast session for providing the content, if it is dynamically determined that a number of requests for the content has exceeded a predetermined threshold number of requests, the number of requests for the content is predicted to exceed the predetermined threshold number of request, or the content is of a predetermined type of content; and
dynamically establish the dedicated session for providing the content, if it is dynamically determined that a number of requests for the content has not exceeded a predetermined threshold number of requests, the number of requests for the content is not predicted to exceed the predetermined threshold number of request, and the content is not of a predetermined type of content.

9. The system in accordance with claim 8, wherein the first device is a mobile device.

10. The system in accordance with claim 8, wherein a multicast session has been established for providing the content to the first device:
the input/output portion further configured to:
receive a request to provide the content to at least one other device different from the first device; and
for each of the at least one other device having a respective location that is the same as a first location of the first device, provide the content thereto via the established multicast session for the first location;
provide the content to the at least one other device having a respective location that is not the same as a first location via a multicast session established for the respective location; and
the processing portion further configured to:
determine the first location of the first device;
determine a respective location for each of the at least one other device;
for each of the at least one other device having a respective location that is not the same as the first location, establish the multicast session for providing the content within each location that is not the same as the first location.

11. The system in accordance with claim 10, wherein each location is respectively indicative of one a cellular site or a sector within a cellular site.

12. The system in accordance with claim 8, wherein the content is indicative of at least one of graphic content, video content, audio content, textual content, or multimedia content.

13. The system in accordance with claim 8, wherein the predetermined type of content comprises content indicative of an event to be provided concurrent with occurrence of the event.

14. The system in accordance with claim 8, wherein the predetermined type of content comprises content indicative of at least one of a sporting event, a concert, a traffic report, a news report, or a recorded event.

15. A method for providing content to a plurality of devices, the method comprising:
receiving a request to provide content to a first device;
determining a first location of the first device;
dynamically, upon receipt of the request to provide content to the first device, determining if a session has been established for providing the content to the first device in the first location;
if it has been determined that no session has been established for providing the content to the first device in the first location:
dynamically establishing a first session for providing the content to the first device in the first location; and
providing the content to the first device via the first session;
receiving a request to provide the content to at least one other device different from the first device;
dynamically, upon receipt of the request to provide the content to the at least one other device, determining a respective at least one location for each of the at least one other device; and
for each of the at least one other device having a respective location that is the same as the first location, providing the content thereto via the first session.

16. The method in accordance with claim 15, wherein the device is a mobile device.

17. The method in accordance with claim 15, wherein:
the first device and the at least one other device are located within a first cellular site; and
the first device and the at least one other device receive the content from a common cellular transmission station providing coverage to the first cellular site.

18. The method in accordance with claim 15, wherein the first device is located in a first cellular site and a second device of the at least one other device is located in a second cellular site, the method further comprising:
upon receiving a request to provide the content to the second device, dynamically determining that the first device is located in the first cellular site and the second device is located in the second cellular site;
dynamically establishing a channel for providing the content within the second cellular site; and
providing the content to the second device via the channel.

19. The method in accordance with claim 15, wherein the content is indicative of at least one of graphic content, video content, audio content, textual content, or multimedia content.

20. The method in accordance with claim 15, wherein:
the content is indicative of an event; and
the content is provided to the first device and the at least one other device concurrent with occurrence of the event.

21. A system for providing content to a plurality of devices, the system comprising:
an input/output portion configured to:
receive a request to provide content to a first device within a first location;
receive a request to provide content to at least one other device different from the first device;
provide the content to the first device via a first session;
for each of the at least one other device having a respective location that is the same as the first location, provide the content thereto via the first session;
a processing portion configured to:
dynamically determine the first location of the first device;
dynamically determine the respective at least one location for each of the at least one other device;
dynamically determine if a session has been established for providing the content to the first device in the first location;
if it is determined that no session has been established for providing the content to the first device in the first location, dynamically establish the first session; and
a memory portion configured to store:
an indication of the first location; and
an indication of the content being provided to the first location.

22. The system in accordance with claim 21, wherein the device is a mobile device.

23. The system in accordance with claim 21, wherein:
the first device and the at least one other device are located within a first cellular site; and
the first device and the at least one other device receive the content from a common cellular transmission station providing coverage to the first cellular site.

24. The system in accordance with claim 21, wherein the first device is located in a first cellular site and a second device of the at least one other device is located in a second cellular site, the processing portion further configured to, upon receiving a request to provide the content to the second device:
dynamically determine that the first device is located in the first cellular site and the second device is located in the second cellular site;
dynamically establish a channel for providing the content within the second cellular site;
and
providing the content to the second device via the channel.

25. The system in accordance with claim 21, wherein the content is indicative of at least one of graphic content, video content, audio content, or multimedia content.

26. The system in accordance with claim 21, wherein:
the content is indicative of an event; and
the content is provided to the first device and the at least one other device concurrent with occurrence of the event.

27. The system in accordance with claim 21, wherein a base station controller of a telecommunications network comprises the input/output portion, the processing portion, and the memory portion.
